(19) United States
(12) Patent Application Publication
(10) Pub. No.: US 2007/0016545 A1
(43) Pub. Date: Jan. 18, 2007

(54) Detection of missing content in a searchable repository

(75) Inventors: Andrei Z. Broder, New York, NY (US); David Carmel, Haifa (IL); Adam Darlow, Haifa (IL); Shai Fine, Ra'anana (IL); Elad Yom-Tov, Hoshaya (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/181,324

(22) Filed: Jul. 14, 2005

(51) Int. Cl. G06F 17/30

(52) U.S. Cl. 707/1

(57) ABSTRACT

A method and system for the detection of missing content in a searchable repository is provided. A system includes: a missing content query identifier (401) for identifying queries to a search engine (102) for which no or little relevant content is returned; a missing content detector (110) which clusters missing content queries by topic; and an output provider for providing details of a missing content topic.

### FIELD OF THE INVENTION

This invention relates to the field of information search and retrieval. In particular, this invention relates to detecting unsatisfactory or missing content in a searchable repository.

### BACKGROUND OF THE INVENTION

Searchable repositories may take many forms including enterprise Web sites, Intranets, departmental servers, etc. The improvements in Web searching has increased user expectations for enterprise searches. However, often these expectations are not met and a user has the frustration of not being able to locate a document in an enterprise searchable repository.

Often, the reason for enterprise search failure is not a failure of the search engine per se, but a content problem. That is, the document expected by the user simply does not exist or it is not “search friendly” (e.g. not accessible, without proper title, tags, etc). In contrast to the classic IR (information retrieval) situation, where a search engine is simply responsible for finding the best document in a given collection, in the modern enterprise, the provider of search engine (e.g. the CIO office) is often simultaneously responsible for the content to be indexed. Thus, it becomes necessary to provide tools to help this provider identify and solve the content problems.

A search engine manager has very few tools from which to assess the quality of the search with regards to his clients' needs. Most tools only measure operational parameters such as response time, etc. Deeper insight as to the response of the search engine to the users' needs is lacking.

Quality testing and monitoring is an important means for improving the effectiveness of an enterprise search engine. Such tools are useful not only to the users of the search engine but to its administrators as well. Improving search quality can reduce the query load on the engine and consequently allow for better allocation of resources. Reducing the duration of the user interaction with the search engine per query can help gain immediate user satisfaction but more importantly it can generate significant savings for companies by empowering employees to find the information they need.

While every search engine employs its own quality techniques to tune its ranking algorithms, the problem with search quality often resides elsewhere. Specifically, one of the problems that are not well addressed in search quality testing is the testing of the content and coverage of the searchable information.

An aim of the present invention is to offer a system and method by which a search engine manager will gain knowledge as to how his users' needs are answered by the search engine.

Specifically, the proposed method enables the administrator to detect user queries for which no relevant answers exist in the data collection, or that relevant data exists but it is not searchable friendly.

### SUMMARY OF THE INVENTION

According to a first aspect of the present invention there is provided a method for detection of missing content in a searchable repository, comprising: identifying queries to a search engine for which no or little relevant content is returned; clustering missing content queries by topic; and providing details of a missing content topic.

The step of identifying queries may be by use of implicit indictors, by user feedback, or by a method of machine learning. In the method of machine learning, the step of identifying queries may include: dividing an input query into a multiplicity of sub-queries and providing said input query and said multiplicity of sub-queries to a search engine; and classifying if a query is a missing content query. Classifying a missing content query may include generating an overlap vector of the extent of overlap between said query documents for said input query and said query documents for said sub-queries. Classifying may use a binary tree predictor or histogram predictor to determine if the query is a missing content query or not.

According to a second aspect of the present invention there is provided a system for detection of missing content in a searchable repository, comprising: a missing content query identifier for identifying queries to a search engine for which no or little relevant content is returned; a missing content detector which clusters missing content queries by topic; and an output provider for providing details of a missing content topic.

The missing content query identifier may identify queries by use of implicit indictors, by user feedback, or by a method of machine learning. In the case of machine learning, the missing content query identifier may include: a query divider to divide an input query into a multiplicity of sub-queries and to provide said input query and said multiplicity of sub-queries to a search engine; and a missing content query classifier to determine if a query is a missing content query. The missing content query classifier may include an overlap counter to generate an overlap vector of the extent of overlap between said query documents for said input query and said query documents for said sub-queries. The missing content query classifier may include a binary tree predictor or a histogram predictor to determine if the query is a missing content query or not.

According to a third aspect of the present invention there is provided a computer program product stored on a computer readable storage medium, comprising computer readable program code means for performing the steps of: identifying queries to a search engine for which no or little relevant content is returned; clustering missing content queries by topic; and providing details of a missing content topic.

The computer program product may include computer readable program code means for performing the steps of one of the features defined in the dependent method claims.

According to a fourth aspect of the present invention there is provided a method of providing a service to a customer over a network, the service comprising: identifying queries to a search engine for which no or little relevant content is returned; clustering missing content queries by topic; and providing details of a missing content topic.

The method of providing a service may include any one of the steps defined in the dependent method claims.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a search system including a missing content detection unit in accordance with the present invention;

FIG. 2 is a flow diagram of a method of detecting missing content in accordance with the present invention;

FIG. 3 is a block diagram of a query difficulty prediction unit as known in the prior art;

FIG. 4 is a block diagram of a search system including a missing content query prediction unit in accordance with the present invention;

FIG. 5 is a flow diagram of a method of classifying a missing content query and detected missing content in accordance with the present invention; and

FIG. 6 is receiver operating characteristic (ROC) graph illustrating the performance of a missing content query prediction unit of FIG. 4.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The following definitions are used herein. A “topic” is the information need of a specific customer, while the “query” is a string representing the topic that is submitted to the search engine (SE). Missing content topics (MCT) are defined as topics for which there is no relevant document in the document collection hence all retrieved results are irrelevant, no matter what the query is. Thus MCTs are defined over a topic and a document collection. Missing content queries (MCQ) are queries submitted to the search engine for which there is no relevant document as it relates to a MCT.

The proposed system provides a means to identify and to cluster those queries submitted to a search engine that are apparently answered poorly or not at all. These queries are called “failed queries”. Each cluster of failed queries represents a specific topic, which is called a missing content topic (MCT). The MCT topic is further analyzed to create a description of the cluster and its most relevant keywords. The described system relates to identifying the missing content topic. The solutions to address an identified missing content are wide open.

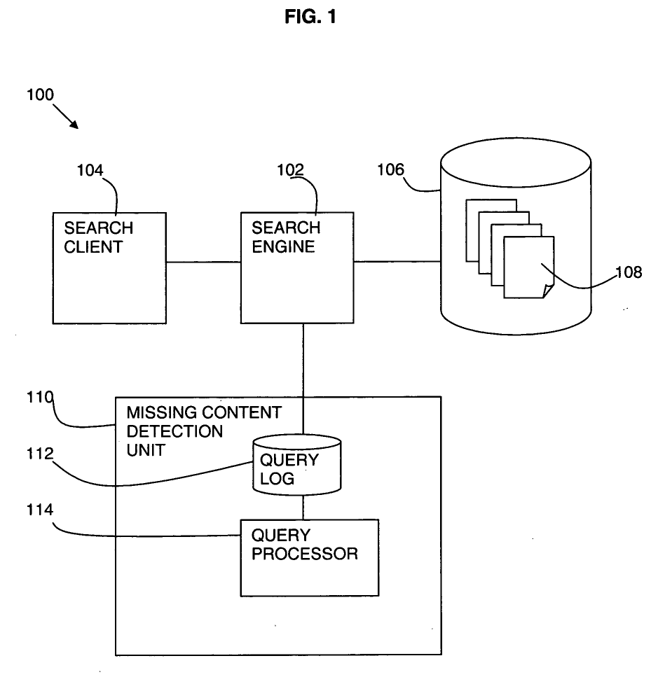

Reference is now made to FIG. 1, which illustrates a search system 100 including a missing content detection unit 110 in accordance with an embodiment of an aspect of the present invention. The search system 100 includes a search engine 102, a search client 104 and a searchable repository 106. The search engine 102 may take the form of a wide range of search engines including, but not restricted to, enterprise search engines for searchable repositories in the form of Web sites, Intranets, other data collections, etc.

As is known in the art, a search client 104 may send search queries to a search engine 102 which provides search results in the form of ranked listings of documents 108 from the searchable repository 106 that match the search query. The search client 104 may then select a document from the list or may request another search.

The missing content detection unit 110 may be external to a search engine such that it is not limited to a specific search engine or method. The missing content detection unit 110 may, alternatively, be integral to a search engine. The missing content detection unit 1 10 may receive data from the search engine in the normal mode of operation of the search engine.

The missing content detection unit 110 includes a query processor 114 which uses information from a query log 112 to detect missing content topics (MCTs) in the searchable repository 106. A query log 112 is a list of all queries submitted to a search engine 102 and may be provided internally or externally to the search engine 102. The query log may be individual to a search client, to a search engine, or to a searchable repository.

The missing content detection unit 110 can operate on a per-query basis as well as using a query log. In this way, a search engine user can get feedback on his query as it is submitted. This is one possible scenario for using the missing content detection unit, however it will be appreciated that there are many other uses.

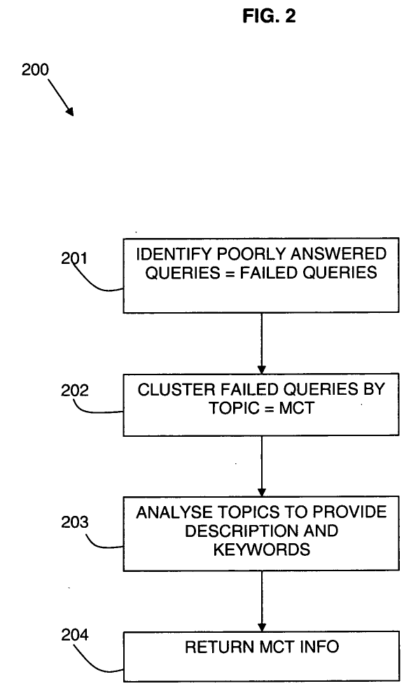

Referring to FIG. 2, a flow diagram 200 shows the operation of the detection unit 110. Poorly answered queries are identified 201. These are referred to as “failed queries”. The failed queries are clustered by topic 202 each of which is a missing content topic (MCT). The topics are analysed 203 to provide a description of the topic and keywords. The description and keywords of the MCTs are returned 204.

The operation of the missing content detection unit 110 has three main stages: (a) identifying the failed queries; (b) clustering these queries; (c) reporting to an editor. Each of these stages is now considered in detail.

Identifying the Failed Queries.

There are several methods possible to identify failed queries.

Firstly, the most direct method is to ask the users for feedback. The problem with this is that few users take the time to answer. Thus, it is necessary to use methods that do not require feedback.

Secondly, methods known as “implicit ratings” or “implicit indicators” can be used. The implicit indicators allow every search interaction to be evaluated. Implicit indicators were the subject of a recent SIGIR workshop: http://research.microsoft.com/˜sdumais/SIGIR2003/SIGIR2003-ImplicitWorkshop.htm

Some known implicit indicators include the following:
“Click-through” data can be identified. This is data indicating if the searcher clicked on any result or if they immediately reformulated the query.
Instrumented browsers can be used that keep track of time spent, scrolling activity, etc. on result pages.
Queries that do not match any results are obviously failed queries. Although, misspellings need to be filtered out.

Other proposed indicators which may be used include the following:
Scores returned by the search engine. For example, if result 200 and result 1 have fairly close scores, it is a good indication that no result really answered the query well.
Machine learning methods can be used to determine other parameters (over the set of 10 top results) that are predictors of low satisfaction with the query. To this end indicators can be provided just from the “failed queries” identified by user surveys.

Thirdly, another method that can be used to locate failed queries by estimating query difficulty using methods from machine learning. A query difficulty prediction unit and method are disclosed in U.S. patent application Ser. No. 10/968692 “Prediction of Query Difficulty for a Generic Search”. The disclosure of the foregoing application is incorporated by reference into the present application.

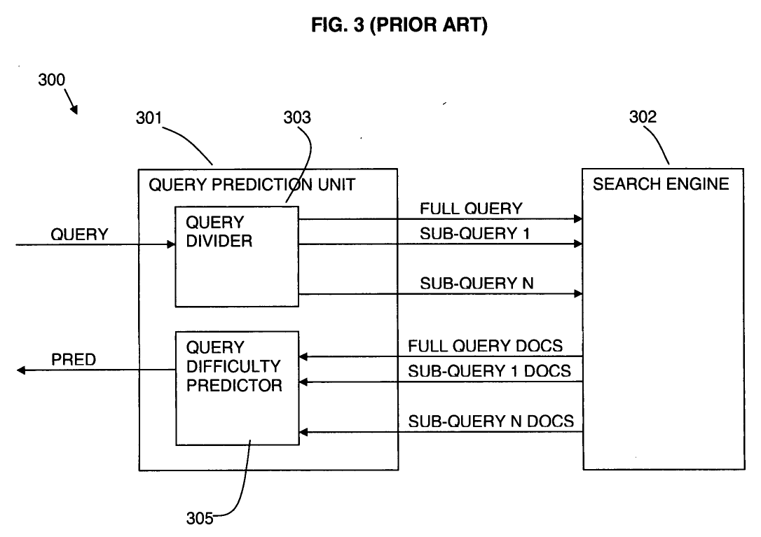

Referring to FIG. 3, a system 300 for estimating query difficulty is illustrated as known in the art and as disclosed in U.S. patent application Ser. No. 10/968692. A query prediction unit 301 operates with a search engine 302 providing it with queries and receiving query documents. The unit 301 includes a query divider 303 and a query difficulty predictor 305. The query divider 303 divides the user's full query into a multiplicity of sub-queries, where a sub-query may be any suitable keyword and/or set of keywords from among the words of the full query. For example, a sub-query may be a set of keywords and lexical affinities (i.e. closely related pairs of words found in proximity to each other) of the full query.

The query divider 303 provides the full query and the sub-queries to the search engine 302 which generates query documents for each query. The query difficulty predictor 305 receives the documents and compares the full query documents to the sub-query documents and generates a query difficulty prediction value based on the comparison.

The query prediction unit 301 may be external to the search engine 302 and may receive a ranked list of relevant documents from the search engine 302 in its normal mode of operation. As a result, the query prediction unit 301 is not limited to a specific search engine or search method.

Two embodiments of the query difficulty predictor 305 are described in the referenced disclosure U.S. patent application Ser. No. 10/968692. Both embodiments use the features of the overlap between documents located by each sub-query and the full query and the document frequency of each of the sub-queries. The first embodiment uses an overlap counter, a binary histogram generator, a histogram ranker and a rank weighter. The rank weighter generates a query difficulty prediction value. The second embodiment uses an overlap counter, a number of appearances determiner and a binary tree predictor.

In an embodiment of the present invention, a modified version of the algorithms disclosed in the referenced disclosure U.S. patent application Ser. No. 10/968692 are used for detecting missing content queries (MCQ). The modification is that instead of training the algorithms for estimating a given target value such as the precision at 10 (P@10) or the average precision (MAP), the algorithms are trained to predict the likelihood that the query is a MCQ. This may be a binary decision (MCQ/non-MCQ query).

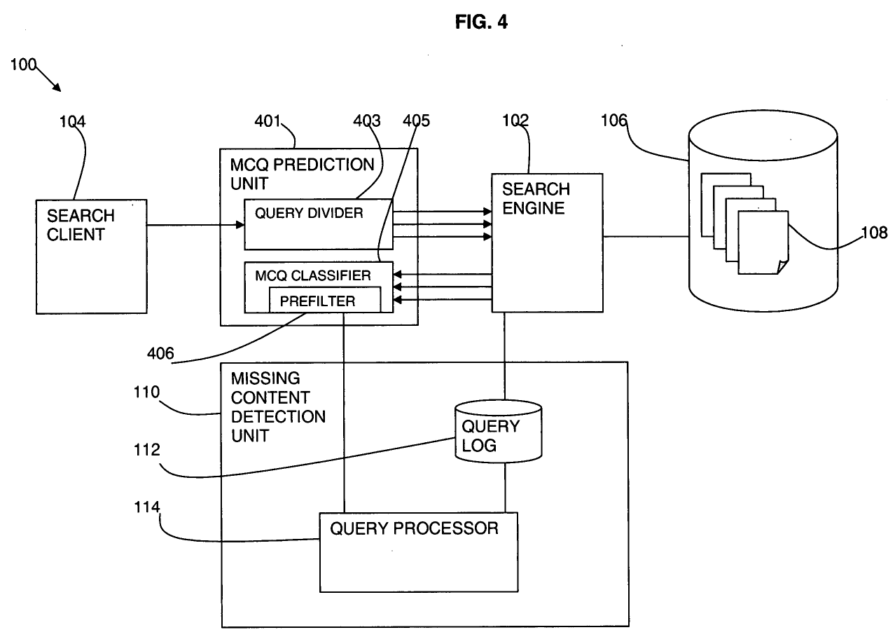

Referring to FIG. 4, a search system 100 in accordance with an embodiment of an aspect of the present invention is shown similar to that of FIG. 1 with the addition of a MCQ prediction unit 401.

The MCQ prediction unit 401 may be combined with the missing content detection unit 110 and may also be external or integral to the search engine 102.

The MCQ prediction unit 401 receives a query from a search client 104. The MCQ prediction unit 401 includes a query divider 403 and the divider 403 breaks each query into sub-queries which consist of the keywords and the lexical affinities of the full query. The sub-queries and the full query are submitted to the search engine 102.

The document results of the sub-queries and full query are returned by the search engine 102 to the MCQ prediction unit 401. Features from the results of the sub-queries and the full query are extracted in the form of the overlap (the number of documents ranked in the top 10 documents of a sub-query which appear in the top 10 documents of the full query) and the document frequency of each sub-query. These features are used by a MCQ classifier 405 to determine if a query is a MCQ.

The MCQ classifier 405 may use a binary-tree estimator to classify MCQs from non-MCQs. Alternatively, the MCQ classifier 405 may use a histogram estimator.

A pre-filter 406 may be provided in the MCQ classifier 405 in the form of a query difficulty predictor unit as known from the referenced disclosure U.S. patent application Ser. No. 10/968692 and as described in FIG. 3. This has the purpose of predicting easy queries which are filtered out so that they are not classified as MCQs.

The missing content detection unit 10 operates as in FIG. 1, with a query processor 114 which processes queries, either on a per-query basis or from the query log 112, to cluster the queries and to detect MCTs in the searchable repository 106. The queries are identified as MCQs by the MCQ classifier 405 of the MCQ prediction unit 401.

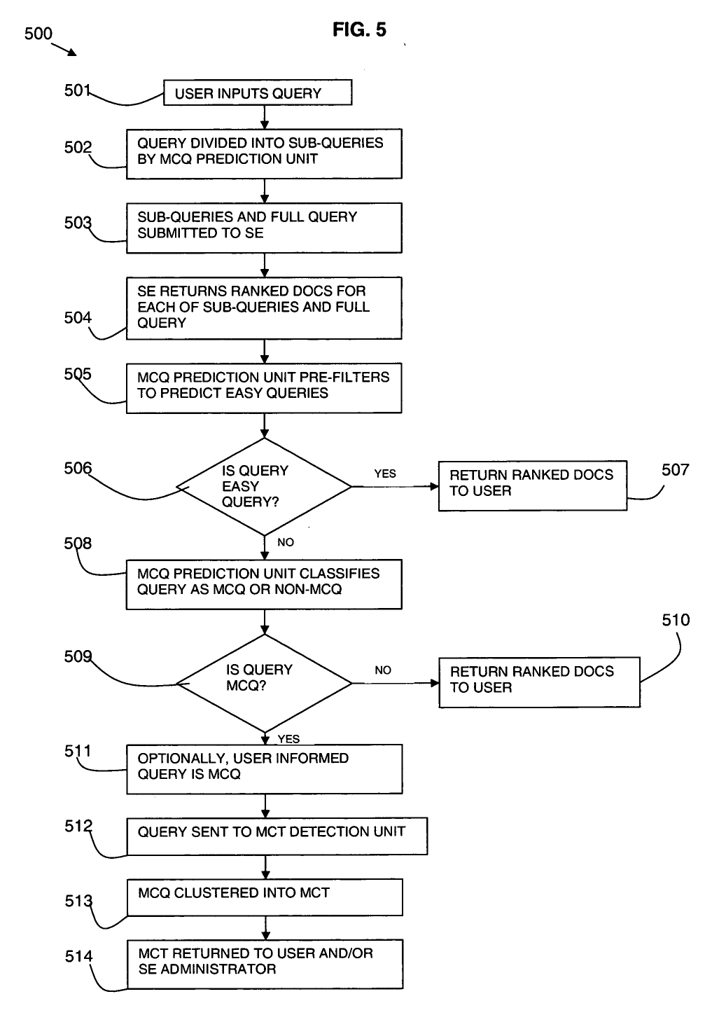

FIG. 5 shows a flow diagram 500 of an embodiment of a method of classifying a missing content query and detected missing content on a per-query basis. A user inputs a query 501 and the query is processed by the MCQ prediction unit by dividing 502 the query into sub-queries and submitting 503 the sub-queries and the full-query to a search engine.

The search engine returns 504 ranked documents for each of the sub-queries and full query. The MCQ prediction unit pre-filters 505 the results to predict easy queries. It is predicted 506 if the query is an easy query. If so, the ranked documents are returned to the user 507. If not, the MCQ prediction unit classifies 508 the query as a MCQ or non-MCQ. It is determined 509 if the query is a MCQ. If it is not a MCQ, the ranked documents are returned to the user 510.

If the query is a MCQ, the user is optionally informed 511 that the query is a MCQ, and the query is sent 512 to the missing content detection unit. The query is clustered with other MCQs into a MCT 513. A description and keywords of the MCT are returned 514 to the user and/or a search engine administrator.

The possibility of using the query estimation algorithms for identifying MCQs has been tested. The test data consisted of the TREC (Text REtrieval Conference) collection, comprising of 528,155 documents and 400 queries on that database. The relevant documents of 166 queries (from a total of 400 queries) were deleted from the TREC collection. Thus, 166 MCQs were artificially created. A tree-based MCQ classifier was then trained to classify MCQs from non-MCQs.

The experiment consisted of two parts:

In the first part of the experiment, the MCQ classifier was trained to distinguish MCQs from non-MCQs.

In the second part, a query difficulty estimator was trained as described in the referenced disclosure U.S. patent application Ser. No. 10/968692 and was used as a pre-filter before the MCQ classifier. Ten-fold cross-validation was used throughout the experiment.

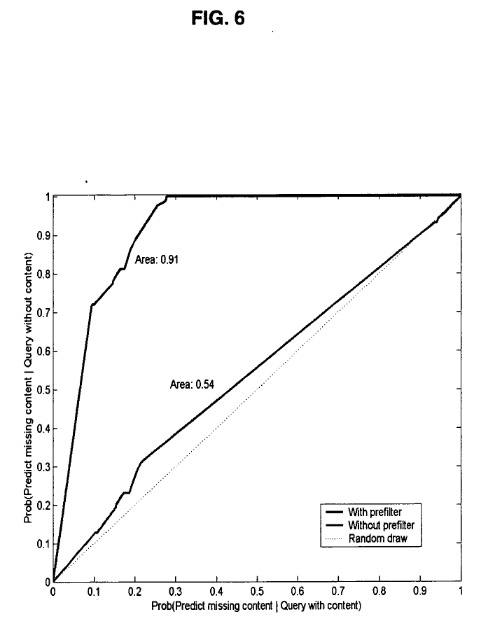

The results of the experiment are shown as a Receiver Operating Characteristic (ROC) curve in FIG. 6. Different points on the graph represent different threshold for deciding if a query is a MCQ or not. This figure shows that the MCQ classifier coupled with a query difficulty estimator is extremely efficient at identifying MCQs. The fact that such a pre-filter is needed (as demonstrated by the poor performance of the classifier without the pre-filter) indicates that the MCQ classifier groups together easy queries with MCQ queries. This is alleviated by pre-filtering easy queries using the difficulty estimation.

Furthermore it is valuable to keep for each failed query its frequency and the confidence that this is indeed a failed query. These factor can be combined into a “failed query weight”.

Clustering the Queries.

Once the set of failed queries is identified, the queries are clustered. Again, there are several possible methods:

One method is to assume that two queries are related if they yield the same clicked documents. This is unlikely to work here since in failed queries with very few clicked documents are of interest. Another method uses both common clicked documents and common content of clicked documents.

A method more likely to be useful for failed queries is as follows.

First, expand the query. The expansion can be done using one or more of the following: terms in internal matched documents; terms in external documents using a larger collection (e.g. a Web search engine); expansions using dictionaries and WordNet, etc.

Second, cluster the queries using standard clustering methods. A greedy method is probably best. The weight of queries can be used. Clusters of relative equal weight are of interest: that is, if a query is very frequent it can be in a cluster by itself, but many low weight queries may be needed to form an interesting cluster.

For example, a well-known clustering algorithm is the k-means algorithm. This starts by assuming a random assignment of queries to clusters and iteratively improves the clustering by alternatively computing the query assignments and the cluster centers based on a distance between the queries. A popular method for measuring distance between queries is using the cosine distance between the vector space representation of the queries.

Reporting the Clusters.

The clusters should be reported to the content provider for two main reasons.
1. If the topic is a MCT topic, the content provider is advised to add this content, which is of interest to his users, to the collection.
2. If the topic is not MCT but simply hard to find, the content provider will be advised to improve the findability using tools developed in the context of Search Engine Optimization (SEO). It is possible to ascertain if a topic is hard to find by measuring the Mutual Information (MI) or the Jensen-Shannon (JS) distance between the topic words and the documents in the collection. If this is low (in the case of MI) or high (in the case of JS) it is indicative of a hard-to-find topic. These tools include adding relevant terms in pertinent locations, adding keywords, etc. In the context of the described system, a list of important keywords is automatically generated by analyzing the queries which define the MCT.

The three participants of information search, namely the user, the search engine manager, and the content provider may be provided with pertinent information regarding single topics for which there are no relevant documents (or only partially relevant) in the collection. This is useful for the user because she will know if the document collection contains answers to her topic, and how to improve the queries to return better documents, if possible. The content provider is benefited by noting information that is of interest to his customers but is not answered by his sources of information.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

The present invention may be provided as a service to a customer over a network. In particular, the service may provide details of missing content topics to an end user of a search engine, a search engine manager or a content provider.

Improvements and modifications can be made to the foregoing without departing from the scope of the present invention.

We claim:

1. A method for detection of missing content in a searchable repository, comprising:
identifying queries to a search engine for which no or little relevant content is returned;
clustering missing content queries by topic; and
providing details of a missing content topic.

2. A method according to claim 1, wherein identifying queries includes:
dividing an input query into a multiplicity of sub-queries and providing said input query and said multiplicity of sub-queries to a search engine; and
classifying if a query is a missing content query.

3. A method according to claim 2, including pre-filtering with a query difficulty prediction before the step of classifying.

4. A method according to claim 1, including providing a missing content query weighting.

5. A method according to claim 1, wherein identifying queries uses implicit indicators in the form of any one or more of: queries with no result documents, queries with result documents none of which are selected, results of instrumented browsers, comparison of result scores, machine learnt parameters for missing content queries.

6. A method according to claim 1, wherein identifying queries is by user feedback.

7. A method according to claim 1, wherein clustering queries by missing content topic includes expanding the queries and using a clustering method to group the queries according to topic.

8. A method according to claim 7, wherein the clustering method uses a missing content query weighting.

9. A method according to claim 1, wherein the method includes analysing the clustered topics to provide keywords and/or a description for a missing content topic.

10. A system for detection of missing content in a searchable repository, comprising:
a missing content query identifier for identifying queries to a search engine for which no or little relevant content is returned;
a missing content detector which clusters missing content queries by topic; and
an output provider for providing details of a missing content topic.

11. A system according to claim 10, wherein the missing content query identifier includes:
a query divider to divide an input query into a multiplicity of sub-queries and to provide said input query and said multiplicity of sub-queries to a search engine; and
a missing content query classifier to determine if a query is a missing content query.

12. A system according to claim 10, wherein the missing content query identifier includes a query difficulty prediction pre-filter.

13. A system according to claim 10, wherein the missing content query identifier provides a missing content query weighting.

14. A system according to claim 10, wherein the missing content query identifier identifies queries by implicit indicators in the form of one or more of: queries with no result documents, queries with result documents none of which are selected, results of instrumented browsers, comparison of result scores, machine learnt parameters for missing content queries.

15. A system according to claim 10, wherein the missing content query identifier identifies queries by user feedback.

16. A system according to claim 10, wherein the missing content detector includes a query expander and a cluster means, wherein the cluster means groups the queries according to topic.

17. A system according to claim 16, wherein the cluster means uses a missing content query weighting provided by the missing content query identifier.

18. A system according to claim 10, wherein the missing content detector includes an analyser providing keywords and/or a description for a detected missing content topic to the output provider.

19. A computer program product stored on a computer readable storage medium, comprising computer readable program code means for performing the steps of:
identifying queries to a search engine for which no or little relevant content is returned;
clustering missing content queries by topic; and
providing details of a missing content topic.

20. A method of providing a service to a customer over a network, the service comprising:
identifying queries to a search engine for which no or little relevant content is returned;
clustering missing content queries by topic; and
providing details of a missing content topic.
